(19) United States
(12) Patent Application Publication
(10) Pub. No.: US 2026/0179472 A1
(43) Pub. Date: Jun. 25, 2026

(54) ALTERNATE OPERATIONAL PATHS DURING FIRE SYSTEM FAILURES

(71) Applicant: Honeywell International Inc., Charlotte, NC (US)

(72) Inventors: Manoj Thankappan Nair, Bengaluru (IN); Kenneth E. Aron, Atlanta, GA (US); Sameer Tripathi, Bengaluru (IN); Asha Nandan Malakar, Bengaluru (IN)

(21) Appl. No.: 18/987,935

(22) Filed: Dec. 19, 2024

(51) Int. Cl. G08B 29/02

(52) U.S. Cl. CPC G08B 29/02

(57) ABSTRACT

Devices, systems, and methods for alternate operational paths during fire system failures are described herein. In some examples, one or more embodiments include a computing device comprising a processor and a memory having instructions stored thereon which, when executed by the processor, cause the processor to receive an indication of an event detected by an event system installed in a facility, determine a failure in an operational path of the event system while the event is occurring, and select and execute an alternate operational path while the event is occurring responsive to the determination of the failure.

### TECHNICAL FIELD

The present disclosure relates to devices, systems, and methods for alternate operational paths during fire system failures.

### BACKGROUND

Facilities, such as commercial facilities, office buildings, hospitals, campuses (e.g., including buildings and outdoor spaces), and the like, may have an event system that can be triggered during an event, such as an emergency situation (e.g., a fire). Such an event system can function to warn occupants to evacuate, mitigate against the emergency situation, and/or control elements within a facility during the emergency situation (e.g., doors, elevators, heating, ventilation, and air conditioning (HVAC), smoke control systems, etc.). An event system may include an alarm system having a control panel and a number of event devices (e.g., sensors, sounders, pull stations, etc.) located throughout the facility (e.g., on different floors and/or in different rooms of the facility) that can perform an action when an event (e.g., a hazard event, a fault event, etc.) is occurring in the facility. In an example of an event, the number of event devices may provide a notification of the event to the occupants of the facility via alarms and/or other mechanisms.

### BRIEF DESCRIPTION OF THE DRAWINGS

FIG. 1 is an example of a system for alternate operational paths during fire system failures, in accordance with one or more embodiments of the present disclosure.

FIG. 2 is a flow chart associated with alternate operational paths during fire system failures in accordance with one or more embodiments of the present disclosure.

FIG. 3 is another flow chart associated with alternate operational paths during fire system failures in accordance with one or more embodiments of the present disclosure

FIG. 4 illustrates a plurality of zones in a facility, each having an input device and an output device, in accordance with one or more embodiments of the present disclosure.

FIG. 5 is an example of a computing device for alternate operational paths during fire system failures, in accordance with one or more embodiments of the present disclosure.

### DETAILED DESCRIPTION

Devices, systems, and methods for alternate operational paths during fire system failures are described herein. In some examples, one or more embodiments include a computing device comprising a processor and a memory having instructions stored thereon which, when executed by the processor, cause the processor to receive an indication of an event detected by an event system installed in a facility, determine a failure in an operational path of the event system while the event is occurring, and select and execute an alternate operational path while the event is occurring responsive to the determination of the failure.

A facility can utilize an event system in order to warn occupants of the facility of an emergency event, such as a fire. An event system can be a system of devices that operate to collect information about a facility and provide the collected information for analysis. Such an event system can also take actions based on the collected information, such as providing an audible and/or visible warning in an emergency event. For example, the event system can utilize event devices to warn occupants of the emergency event occurring in the space, such as a fire. As used herein, the term “event device” refers to a device that can receive an input relating to an event and/or generate an output relating to an event. Such event devices can be a part of the event system of a space in a facility/in the facility at large and can include devices such as fire sensors, smoke detectors, heat detectors, carbon monoxide (CO) detectors, or combinations of these; air quality sensors; interfaces; manual call points (MCPs); pull stations; input/output modules; aspirating units; and/or audio/visual devices (e.g., speakers, sounders, flashers, buzzers, microphones, cameras, video displays, video screens, etc.), relay output modules, among other types of event devices.

Failures may occur within an event system. Failures may be failures of an event device, failures within a fire panel, and/or failures of the event system network, for instance. Failures can be caused by a malfunctioning device and/or a failure to execute some logic. In some cases, a failure may be deemed a deviation from an expected (or a desired) behavior of one or more devices of an event system during an event.

In previous approaches, failures may be determined using manual checks. This introduces the risk of human error and makes it challenging to promptly identify instances where the expected behavior(s) have not been triggered. For instance, a human may not know what has been configured and/or how to check for its execution. Without automated alerts for system failure of configured logics, there is a heightened risk of delayed emergency response because information regarding the extent of an event, such as a fire, or the failure of safety mechanisms may not reach responders in a timely manner. In scenarios where logic and/or rules fail to execute, occupants and assets may be left vulnerable to the escalating event, compromising safety and increasing the potential for severe damage and/or casualties. Additionally, the lack of automated detection for system failure hinders the system's ability to conduct effective post-event analysis, which limits insights into the root causes of failures and impedes efforts to enhance the system's resilience for future events.

Embodiments of the present disclosure include an internal monitoring system for a panel of an event system (referred to herein as a “fire panel”) that bolsters the reliability of the event system. Embodiments herein can operate by continually assessing the activation status of system logic operations. Logic operations include (C&E) systems, multi-dependency logics, delayed operations, and/or scheduled operations, for instance, among others.

Logical operations can be triggered by inputs. Inputs triggering logical operations include events of the system, such as emergency events marked by alarms (e.g., fire alarms, security alarms, technical alarms, auxiliary alarms, pre-alarms, etc.) and/or faults (e.g., faults detected and triggers by the system). Inputs triggering logical operations include output activations. Stated differently, an event raised due to an output being operated can in turn be used as input into logical operation. Output actions (sometimes referred to herein simply as “outputs”) include notifications (e.g., sounders, strobes, hooters, speakers, flashers, etc.), protection and extinguishing actions, control actions (e.g., fire door, elevator, HVAC, smoke control, etc.).

According to a given logical operation, a particular input (or set of inputs) is expected to lead to a particular output (or set of outputs). A deviation from this causal relationship is referred to herein as a failure in the performance of an output action, a failure in the activation of one or more system components, or simply a “failure.” Failures can be detected. Embodiments herein can identify the impact of the detected failure by evaluating the local operations and the output actions thereon.

C&E rules play a vital role in event alarm systems. C&E rules provide the process of mapping, initiating sensors, and notification appliances to interoperate to identify particular events and provide correspondingly appropriate particular notifications to users of the alarm system, occupants of the facility, system monitoring personnel, emergency personnel, facility ownership, and/or system maintenance personnel based on the particular type of event identified. Activating appropriate audible and/or visual notifications, initiating voice alarm notifications, playing evacuation and/or alert messages on a user's computing device at a right time and/or in the right places are important factors to life safety at a facility.

C&E rules can dictate operational paths. As referred to herein an “operational path” is the programmed connection between one or more inputs and one or more outputs within an event system. An operational path can encompass an input (or inputs) corresponding to a particular zone of a facility and an output (or outputs) corresponding to that zone. In an example, inputs indicative of a detected fire in zone 5 can, according to the programmed operational path, cause sounder outputs in zone 5.

However, when failures occur, an operational path may no longer be viable. Previous approaches that employ one operational path for a given input or set of inputs compromise safety when failures occur. Embodiments of the present disclosure provide a highly reliable event system that offers multiple alternate operational paths to provide increased safety, even in the event of a failure.

For instance, embodiments herein can detect failures in input devices, output devices, and/or programmed operations relating input to output. Embodiments herein provide programmable alternate operational paths for outputs to a particular zone and/or neighboring zones and/or other zone combinations based on inputs. A zone, as referred to herein, is an indivisible unit of space (e.g., measured in square feet, square meters, etc.) of a facility that is protected by an event system. Zones, depending on their usages, can contain various resources, people, property, and/or infrastructure. Alternate operational paths can be programmable (e.g., by a user) and can be stored and selected for execution based on the severity of a given failure. As discussed further below, severity levels can range from a first severity level (e.g., low risk) to a fourth severity level (e.g., critical risk). Alternate operational paths can include the activation of output devices in neighboring zones when a failure of an output device is determined during an event. Alternate operational paths can include the correlation of input devices in neighboring zones to the output devices of a zone containing failed input devices. In some embodiments, main CPU failures, loop module failures, network communications failures, and/or complete fire panel failures, for instance, can cause the activation of alternate panels as a part of an executed alternate operational path.

In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

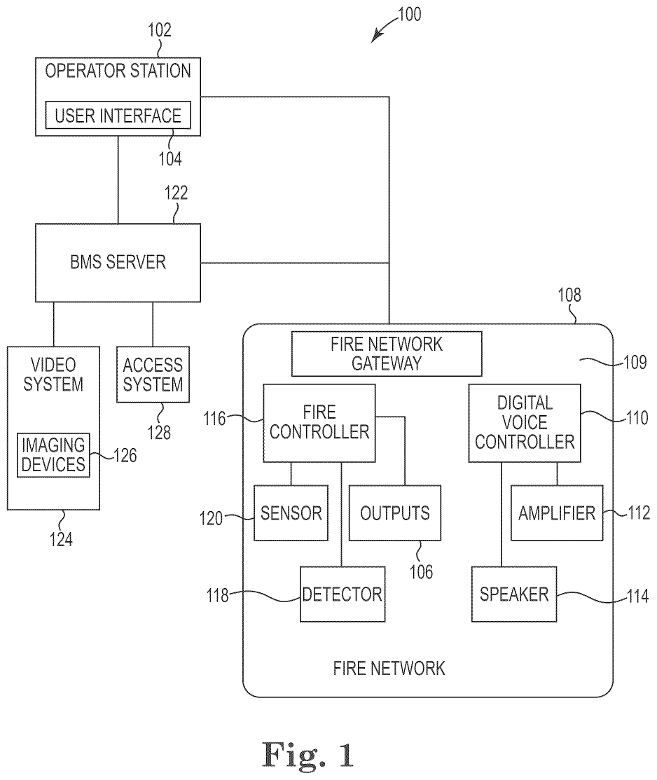

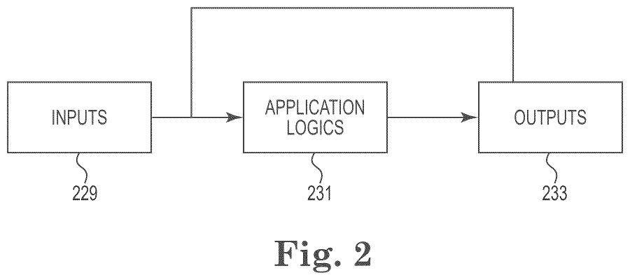

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 402 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example of a system 100 for alternate operational paths during fire system failures, in accordance with one or more embodiments of the present disclosure. As shown in FIG. 1, system 100 can include an operator station 102, outputs 106 (discussed below in connection with FIGS. 2 and/or 3), a fire network 108, a BMS server 122, a video system 124, and an access system 128. However, systems for in accordance with embodiments of the present disclosure are not limited to the embodiment illustrated in FIG. 1 (e.g., various systems can include elements not illustrated in system 100 and/or exclude elements illustrated in system 100).

Operator station 102 can be a computing device (e.g., having a processor and a memory as discussed below in connection with FIG. 2). Although one operator station is shown in FIG. 1, embodiments of the present disclosure can include multiple operator stations. Various users can access operator station 102 and each user can be authenticated before being allowed access.

Operator station 102 can include a user interface (e.g., display) 104. User interface 104 can be and/or include various display technologies such as, for example, liquid crystal display (LCD), light emitting diode (LED) display, cathode ray tube (CRT) display, etc., and can display videos, data, and/or information to one or more users. Operator station 102 can include additional components such as one or more microphones, for instance, among others (not shown in FIG. 1).

As shown in FIG. 1, fire network 108 can include a fire network gateway 109, a digital voice controller 110 coupled to a speaker 114 and an amplifier 112, and a fire controller 116 coupled to a detector 118 and a sensor 120. However, fire networks in accordance with embodiments of the present disclosure are not limited to the particular devices illustrated in FIG. 1. For example, fire network 108 can include multiple sensors, detectors, speakers and/or amplifiers, among other devices.

Fire network gateway 109 can be a component configured to control a rate at which audio is sent to controllers of fire network 108 (e.g., digital voice controller 110 and/or fire controller 116). For example, fire network gateway 109 can allow maintaining of audio quality and/or prevention of buffer underrun and/or overrun. Digital voice controller 110 can be a device configured to interface with and/or manage various audio devices (e.g., amplifier 112 and/or speaker 114). Amplifier 112 can be various types of amplifiers, and embodiments of the present disclosure are not limited to particular types of amplifiers. Similarly, speaker 114 can be various types of speakers, and embodiments of the present disclosure are not limited to particular types of speakers. For example, a facility can include a plurality of digital voice controllers, speakers, and/or amplifiers of various types, for instance, dispersed throughout the facility.

Fire controller 116 can be a device configured to interface with and/or manage various fire devices (e.g., detector 118 and/or sensor 120). The fire controller 116 can be a fire control panel. As used herein, the term “control panel” refers to a device at the facility to control components of an alarm system of a facility (e.g., building). For example, the fire controller 116 can be a fire control panel that can receive information from event detection devices and determine whether an emergency event (e.g., a fire) is occurring or has occurred. The fire controller 116 can store C&E rules. In some embodiments, the C&E rules are included in a configuration file stored by the fire controller 116.

As used herein, the term “alarm system event detection device” refers to a device that can send data regarding an event occurring in the device's coverage area (where it can sense an event occurring) and/or receive an input relating to an event. Such alarm system event detection devices can be a part of an alarm system of the facility and can include devices such as fire sensors, smoke detectors, heat detectors, carbon monoxide (CO) detectors, other chemical detector(s), or combinations of these; interfaces; pull stations; input/output modules; aspirating units; and/or audio/visual devices, such as speakers, sounders, buzzers, microphones, cameras, video displays, video screens, and other detector devices, among other types of alarm system devices.

Accordingly, detector 118 can be various types of detectors (e.g., a smoke detector), and embodiments of the present disclosure are not limited to particular types of detectors. Similarly, sensor 120 can be various types of sensors (e.g., a temperature sensor), and embodiments of the present disclosure are not limited to particular types of sensors. For example, a facility can include a plurality of fire controllers, detectors, and/or sensors of various types, for instance, dispersed throughout the facility.

BMS server 122 can include one or more devices (e.g., computing devices, not shown in FIG. 1) configured to perform various functions discussed below, for instance. BMS server 122 can interact with and/or manage various systems and/or subsystems of a BMS system (e.g., energy systems, heating, ventilating, and air conditioning (HVAC) systems, etc.) (not illustrated in FIG. 1).

In some embodiments, BMS server 122 and/or operator station 102 can be located separately (e.g., remotely, such as in a different geographical location and/or facility) with respect to fire network 108, video system 124, and/or access system 128. Whereas fire network 108, video system 124, and/or access system 128 can be associated with a particular facility, locations associated with BMS server 122 and/or operator station 102 are not so limited. For example, operator station 102 can be located at a first geographical location (e.g., a BMS command center), and fire network 108, video system 124, and/or access system 128 can be located at a second geographical location (e.g., the facility).

Video system 124 can manage a video system associated with a facility. Video system 124 can include a plurality of imaging devices 126 and/or one or more computing devices (not illustrated in FIG. 1). Imaging devices 126 can be various types of imaging devices (e.g., video cameras), and embodiments of the present disclosure are not limited to particular types of imaging devices. For example, imaging devices 126 can be dispersed throughout a facility. Each of imaging devices 126 can capture a respective video of a portion of a facility and communicate the captured video to operator station 102, for instance.

Access system 128 can manage access, security, and/or occupancy associated with a facility. Access system 128 can include various sensors, identification card scanners, lighting systems, alarm systems, etc. (not shown in FIG. 1). Although shown in FIG. 1 as being separate from video system 124 in some embodiments, access system 128 can be integrated and/or correlated with video system 124.

A user can be authenticated and/or gain access to operator station 102 such that the user can visualize user interface 104. User interface 104 can display various interfaces that can be customized by the user, for instance. For example, user interface 104 can display a graphical representation of the facility, fire network 108 and/or a portion of fire network 108. Such a graphical representation can include a floor plan (e.g., two or three-dimensional rendering) of a facility housing fire network 108, for instance, along with locations (e.g., denoted by icons) of various components of fire network 108 (e.g., digital voice controller 110, amplifier 112, and/or speaker 114). Such a graphical representation can include a hierarchical tree view form of the facility model (e.g., derived from existing facility model of the BMS). Such components may be selectable in various manners (e.g., a mouse click).

The graphical representation can include depictions of entities in the facility. In some embodiments, for instance, the locations of people can be depicted using display elements. In some embodiments, a fire, or other cause of an emergency can be depicted graphically with animations.

An event alarm signal can be generated in response to data from one or more alarm system event detection devices (e.g., detector 118 and/or sensor 120) indicating that an event (e.g., fire, emergency situation, etc.) may be occurring. As used herein, the term “event” may refer to any condition occurring within the building, such as a fire, smoke, or chemical sensor activation, an alarm trigger (pull station), or a breach of security.

The fire controller 116 may be configured to transmit information about the emergency event to a computing device and/or a remote network (e.g., a cloud-based network). This information, may include, for example, a unique identifier of the event detection device which detected the event, a date and/or time of the event, a status of the event (e.g., resolved, unresolved), and/or an event type (e.g., smoke detected, communication fault).

Floorplans of each floor of the building may be accessible through the computing device operator station 102. For example, such floorplans may be stored in the memory of the BMS server 1122. These building floorplans may be configured to include specific locations of all of the alarm system event detection devices. These floorplans may be accessed, and portions of the plans may be transferred to the operator station 102 to enable the creation of a visual floor representation as described herein.

FIG. 2 is a flow chart associated with alternate operational paths during fire system failures in accordance with one or more embodiments of the present disclosure. As previously discussed, according to a given logical operation 231, a particular input (or set of inputs) 229 is expected to lead to a particular output (or set of outputs) 233. Inputs 229 are inputs to one or more of the application logics 231 and include inputs received from devices such as from sensors, input modules, and/or communications devices, for instance. Inputs 229 include system events. A system event, as referred to herein, is a type of output 233. For example, a system event can refer to an alarm, a fault, an evacuation, a reset of one or more devices, and/or an activation or deactivation of one or more devices. That is, as shown in FIG. 2, some outputs 233 can also be inputs 229.

In the absence of a failure, application logics 231 turn particular input(s) 229 into particular output(s) 233. Application logics include C&E, multi-dependency logics, and/or delays (confirmation delays, verification delays, output action delays, etc.), for instance.

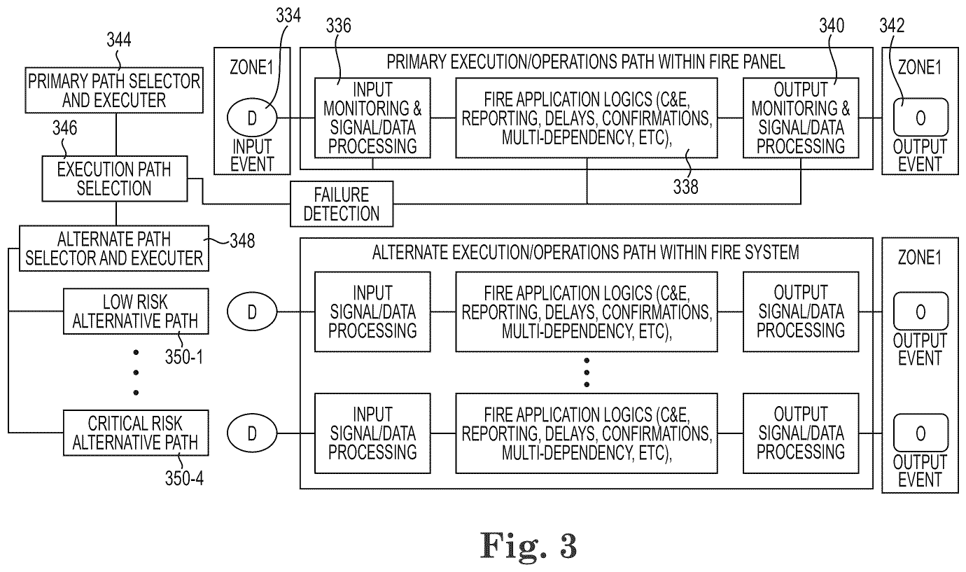

FIG. 3 is another flow chart associated with alternate operational paths during fire system failures in accordance with one or more embodiments of the present disclosure. A primary (e.g., normal) operational path can be executed by a primary path selector and executor 3454. The primary operational path shown in FIG. 3 includes input monitoring and signal/data processing 336, logics 338, and output monitoring and signal/data processing 340 connecting one or more input events 334 and one or more output events 342. Input events can be determined by devices configured to determine the occurrence of an event. Such input devices can communicate the determination of the occurrence of the event to a fire panel, for instance. In accordance with C&E rules, the fire panel may trigger the operation of one or more output devices to change. This may include, for instance, bells to ring, sounders to sound, lights to activate, elevators to stop and remain open, ventilators to be deactivated, etc.

Failure detection mechanisms 343 within each sub-system component of the fire panel can identify failures within each of them respectively. In some embodiments, failure detection mechanisms 343 are executed remotely, outside the panel (e.g., in the cloud). A failure can be a failure of an output device to activate (or deactivate) in accordance with the appropriate logic. A failure can be a failure of communications due to faulty wiring or a network error. A failure can be a failure of the panel to execute the appropriate logic. Failures of devices to activate or deactivate can be determined via respective circuitry on the devices. This circuitry can include resistors and/or sensors (e.g., logic activation sensors) configured to determine whether a device is functioning appropriately based on a given input.

The operational path selector 344 can use the information of failures being detected within the fire panel from any of the sub-system components along the entire execution path from the input device(s) 334 to the output device(s) 342. The operational path selector 346 can assess the severity of the failure that has been detected by the fire panel. This assessment can be based on a severity that is programmed by a user. The execution path selector 346 can perform this operation for any faults and event conditions detected from the fire panel.

If a failure is not identified, then the primary operational path that is programmed by the user can be executed normally on the fire panel. If there is a failure and the severity is assessed based on the user programming or configuration steps can be executed based on the programing of the alternative operational paths from the user. For instance, the alternate path executor 348 can take the fault and alarm event and the severity from the previous step and selects the alternate path to be operationalized based on the programming of the alternate paths by the user. The alternate operational path can be executed by the fire panel based on the finalized selection and, accordingly, the outputs are actions on the specific zone that is impacted by failures in the fire panel.

In some embodiments, a notification associated with the selection and/or the execution of the alternate operational path can be provided. Such a notification can be provided in one or more manners. In some embodiments, the notification is provided to the user interface 104, previously described in connection with FIG. 1. In some embodiments, the notification is provided to a mobile device. In some embodiments, the notification is provided to dedicated lights in a BMS room and/or at the operator station 102, previously described in connection with FIG. 1. In some embodiments, the notification 336 is provided to a user interface on the panel. In some embodiments, the notification 336 is provided to personnel within the facility (e.g., using lighting and/or a public address system).

As previously discussed, multiple levels of alternate operational paths can be programmed for each input failure or output failure based on the severity of the failure(s) in a zone. The example illustrated in FIG. 3 illustrates two available alternate operational paths, a first path 350-1 associated with a first level (e.g., low risk) severity, and a fourth path 350-4 associated with a fourth level (e.g., critical risk) severity. As shown, each of these paths can include their own respective input monitoring and signal/data processing 336, logics 338, and output monitoring and signal/data processing 340.

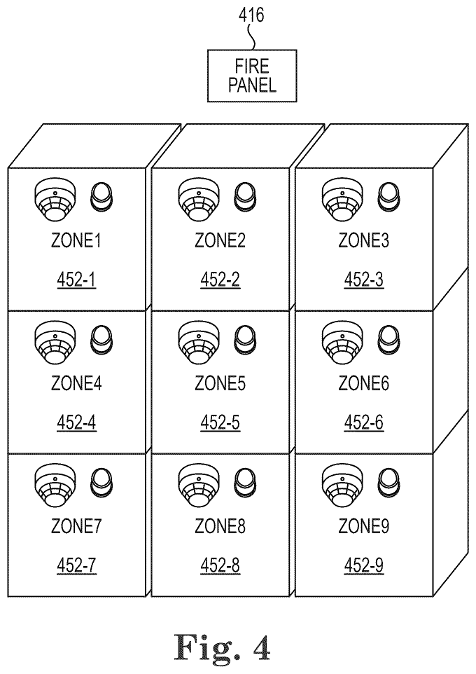

In some embodiments, a first level (e.g., low risk) failure can be determined to have occurred responsive to a determination that the failure implicates a single input device of a zone or a single output device of the zone while the event is occurring. In some embodiments, a second level (e.g., medium risk) failure can be determined to have occurred responsive to a determination that the failure implicates a plurality of input devices of a zone or a plurality of output devices of the zone while the event is occurring. In some embodiments, a third level (e.g., high risk) failure can be determined to have occurred responsive to a determination that the failure implicates a single input device of a zone and a single output device of the zone while the event is occurring. In some embodiments, a fourth level (e.g., critical risk) failure can be determined to have occurred responsive to a determination that the failure implicates a plurality of input devices of a zone and a plurality of output devices of the zone while the event is occurring. Each of these levels can cause the execution of a different alternate operational path, as discussed in more detail below in connection with FIG. 4.

As previously discussed, in some embodiments, main CPU failures, loop module failures, network communications failures, and/or complete fire panel failures, for instance, can cause the activation of alternate panels as a part of an executed alternate operational path. In some cases, a first panel has direct reach (e.g., connection and communication path) to a set of inputs, outputs, or both that are programmed to be operated when suitable input conditions are detected at the inputs. In other cases, a second panel, or additional panels can be connected to the first panel indirectly (e.g., via a network). A failure of the main processing unit, for instance, of the first panel can be determined by the second panel or by one or more of the networked additional panel(s). The alternate paths of execution can programmed at the second panel and/or the multiple networked panels. The input conditions can be detected by the second panel and/or the networked panels together, which can then perform the programmed alternate operations on the required outputs. In this way the alternate paths programmed could be across the networked panels forming the overall fire system to archive fire safety for the facility.

FIG. 4 illustrates a plurality of zones in a facility, each having an input device and an output device, in accordance with one or more embodiments of the present disclosure. The plurality of zones 452 includes a first zone 452-1, a second zone 452-2, a third zone 452-3, a fourth zone 452-4, a fifth zone 452-5, a sixth zone 452-6, a seventh zone 452-7, an eighth zone 452-8, and a ninth zone 452-9. As shown, the plurality of zones 452 are arranged on three levels of a facility. Each of the zones 452 (e.g., the devices of the zones 452) can be in communication with a fire panel 416. In accordance with a primary operational path for a given zone, an input within the zone can cause an output within that zone. For example, an input indicating a fire condition in the fifth zone 452-5 can cause a sounder in the fifth zone 452-5 to be activated. It is noted, however, that a primary operational path is not limited to this simplistic example.

In an example, a failure is determined associated with an input device in the fifth zone 452-5. In accordance with an alternate operational path, the output device of the fifth zone 452-5 can be activated responsive to one or more neighboring zones being in a fire condition (e.g., via inputs of the first zone 452-1, the second zone 452-2, the third zone 452-3, the fourth zone 452-4, the sixth zone 452-6, the seventh zone 452-7, the eighth zone 452-8, and/or the ninth zone 452-9).

In another example, a failure is determined associated with an output device in the fifth zone 452-5. In accordance with an alternate operational path, the input of the fifth zone 452-5 (e.g., fire alarm) can be programmed to trigger outputs (e.g., evacuation outputs) of neighboring zones. In some embodiments, the neighboring zones are on a same level as the zone experiencing the failure (e.g., the fourth zone 452-4 and the sixth zone 452-6).

In another example, a failure is determined associated with an application logic of the fire panel 416 corresponding to the fifth zone 452-5. In accordance with an alternate operational path, a combination of the above two examples may be implemented. For instance, any inputs from any neighboring zones can cause the activation of an output device of any neighboring zones. Stated differently, inputs of the first zone 452-1, the second zone 452-2, the third zone 452-3, the fourth zone 452-4, the sixth zone 452-6, the seventh zone 452-7, the eighth zone 452-8, and/or the ninth zone 452-9 can cause outputs of zones (e.g., the fourth zone 452-4 and the sixth zone 452-6) on the same level as the affected zone 452-5.

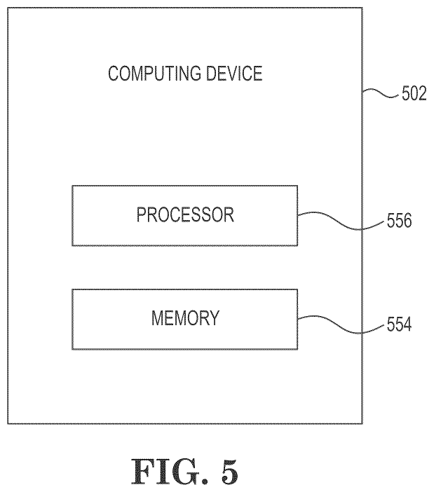

FIG. 5 is an example of a computing device 502 for alternate operational paths during fire system failures, in accordance with one or more embodiments of the present disclosure. As illustrated in FIG. 5, the computing device 502 can include a memory 554 and a processor 556, in accordance with the present disclosure.

The memory 554 can be any type of storage medium that can be accessed by the processor 556 to perform various examples of the present disclosure. For example, the memory 554 can be a non-transitory computer readable medium having computer readable instructions (e.g., executable instructions/computer program instructions) stored thereon that are executable by the processor 556 for alternate operational paths during fire system failures in accordance with the present disclosure.

The memory 554 can be volatile or nonvolatile memory. The memory 554 can also be removable (e.g., portable) memory, or non-removable (e.g., internal) memory. For example, the memory 554 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 554 is illustrated as being located within computing device 402, embodiments of the present disclosure are not so limited. For example, memory 554 can also be located internal to another computing resource (e.g., enabling computer readable instructions to be downloaded over the Internet or another wired or wireless connection).

The processor 556 may be a central processing unit (CPU), a semiconductor-based microprocessor, and/or other hardware devices suitable for retrieval and execution of machine-readable instructions stored in the memory 554.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for alternate operational paths during fire system failures, comprising:
a processor; and
a memory having instructions stored thereon which, when executed by the processor, cause the processor to:
receive an indication of an event detected by an event system installed in a facility;
determine a failure in an operational path of the event system while the event is occurring; and
select and execute an alternate operational path while the event is occurring responsive to the determination of the failure.

2. The computing device of claim 1, wherein the event is a fire.

3. The computing device of claim 1, wherein the failure is associated with at least one of:
application logic of a fire panel of the event system;
an event device of the event system; and
a fire panel of the event system.

4. The computing device of claim 1, wherein the instructions to select the alternate operational path include instructions to select the alternate operational path from among a plurality of operational paths based on a determined severity of the failure.

5. The computing device of claim 4, including instructions to determine the severity based on a quantity of devices implicated in the failure.

6. The computing device of claim 4, wherein the severity is one of:
a first level failure;
a second level failure;
a third level failure; and
a fourth level failure.

7. The computing device of claim 6, including instructions to determine that the failure is a first level failure responsive to a determination that the failure implicates a single input device of a zone of the facility or a single output device of the zone of the facility while the event is occurring.

8. The computing device of claim 6, including instructions to determine that the failure is a second level failure responsive to a determination that the failure implicates a plurality of input devices of a zone of the facility or a plurality of output devices of the zone of the facility while the event is occurring.

9. The computing device of claim 6, including instructions to determine that the failure is a third level failure responsive to a determination that the failure implicates a single input device of a zone of the facility and a single output device of the zone of the facility while the event is occurring.

10. The computing device of claim 6, including instructions to determine that the failure is a fourth level failure responsive to a determination that the failure implicates a plurality of input devices of a zone of the facility and a plurality of output devices of the zone of the facility while the event is occurring.

11. A non-transitory computer readable medium having computer readable instructions stored thereon that are executable by a processor to:
receive user inputs designating a plurality of alternate operational paths, of an event system installed in a facility, for execution responsive to a failure in an operational path of the event system;
receive an indication of an event detected by the event system;
determine a failure in an operational path of the event system while the event is occurring; and
select one of the plurality of alternate operational paths while the event is occurring responsive to the determination of the failure; and
execute the selected one of the plurality of alternate operational paths.

12. The medium of claim 11, wherein the failure is associated with a fire panel of the event system.

13. The medium of claim 12, wherein the instructions to select the one of the plurality of alternate operational paths include instructions to select an alternate path that includes a different fire panel of the event system responsive to a determination that the failure in the operational path implicates the fire panel.

14. The medium of claim 11, including instructions to provide a notification regarding the selection of the one of the plurality of alternate operational paths to a mobile device.

15. The medium of claim 11, including instructions to provide a notification regarding the selection of the one of the plurality of alternate operational paths to a fire panel of the facility.

16. A system, comprising:
a plurality of event devices of an event system in a facility;
a computing device configured to:
receive user inputs designating a plurality of alternate operational paths, of an event system installed in a facility, for execution responsive to a failure in an operational path of the event system, wherein the operational path corresponds to a particular zone of the facility;
receive an indication of an event detected by the event system;
determine a failure in the operational path of the event system while the event is occurring; and
select one of the plurality of alternate operational paths while the event is occurring responsive to the determination of the failure; and
execute the selected one of the plurality of alternate operational paths.

17. The system of claim 16, wherein the plurality of event devices include:
a fire panel;
smoke detectors;
heat detectors;
emergency actuators;
access control devices; and
ventilators.

18. The system of claim 16, wherein the failure is associated with an input device of the particular zone, and wherein the selected one of the plurality of alternate operational paths includes causing an activation of an output device of the particular zone responsive to a neighboring zone being in an event condition.

19. The system of claim 16, wherein the failure is associated with an output device of the particular zone, and wherein the selected one of the plurality of alternate operational paths includes causing an input device of the particular zone to activate an output device of a neighboring zone.

20. The system of claim 16, wherein the failure is associated with an application logic of a fire panel of the event system corresponding to the particular zone, and wherein the selected one of the plurality of alternate operational paths includes causing any inputs from any neighboring zones to activate an output device of any neighboring zone.
